(19) United States
(12) Patent Application Publication
(10) Pub. No.: US 2015/0134263 A1
(43) Pub. Date: May 14, 2015

(54) INFORMATION PROCESSING APPARATUS, INFORMATION PROCESSING METHOD, AND RECORDING MEDIUM

(71) Applicants: Oki Electric Industry Co., Ltd., Tokyo (JP); Chuo University, Tokyo (JP)

(72) Inventors: Kurato MAENO, Tokyo (JP); Kohei YAMAMOTO, Tokyo (JP); Toshinari KAMAKURA, Tokyo (JP)

(73) Assignees: Oki Electric Industry Co., Ltd., Tokyo (JP); Chuo University, Tokyo (JP)

(21) Appl. No.: 14/519,100

(22) Filed: Oct. 20, 2014

(30) Foreign Application Priority Data
Nov. 12, 2013 (JP) 2013-233863

(51) Int. Cl. G01H 1/00

(52) U.S. Cl. CPC G01H 1/00
USPC 702/19

(57) ABSTRACT

There is provided an information processing apparatus including: an input unit inputting first vibration information observed from a moving body; a generating unit generating second vibration information based on a periodic function including at least one parameter that models periodic motion of the moving body; and an estimating unit estimating the at least one parameter based on a comparison result for the first vibration information inputted by the input unit and the second vibration information generated by the generating unit. The estimating unit repeatedly estimates the at least one parameter based on a comparison result for the first vibration information and the second vibration information that has been regenerated by the generating unit using the estimated at least one parameter.

### CROSS REFERENCE TO RELATED APPLICATION(S)

This application is based upon and claims benefit of priority from Japanese Patent Application No. 2013-233863, filed on Nov. 12, 2013, the entire contents of which are incorporated herein by reference.

### BACKGROUND

The present invention relates to an information processing apparatus, an information processing method, and a recording medium.

In recent years, apparatuses that detect movement of the human body, vehicles and other moving objects using various sensors have been introduced. As one example, a technology that detects respiration by the human body using electrical wave or sound wave-type sensors has been developed.

As one example, Hajime Kubo, Taketoshi Mori, Tomomasa Sato, “Detection of Human Motion and Respiration with Microwave Doppler Sensor”, Transactions of the Japanese Society for Medical and Biological Engineering, Vol. 48, No. 6, pp. 595-603, 2010 discloses a technology that extracts three characteristic values (signal strength, frequency domain entropy, and signal histogram) for an output signal from an electrical wave-type sensor and distinguishes between unmanned (i.e., no subject present) state, a manned state (respiration), and a manned state (movement) according to a machine learning method. Note that the signal strength and frequency domain entropy used as characteristic values are calculated using a Fourier transform. Also, a signal histogram is a distribution relating to signal amplitude in a time domain.

### SUMMARY

Since the characteristic values used for identification purposes in the technology disclosed by the cited document are all statistics relating to the time of an output signal, such technology can merely express the speed of a moving body to be identified and the complexity of the movement. For this reason, there has been the problem that even though it is possible to distinguish a manned state (respiration) for example, it has not been possible to evaluate an arbitrary movement component of the living body, i.e., how the moving body is breathing.

The present invention was conceived in view of the problem described above and aims to provide a novel and improved information processing apparatus, information processing method, and a recording medium capable of evaluating an arbitrary movement component of a moving body based on an observation result produced by a sensor.

According to an embodiment of the present invention, there is provided an information processing apparatus which includes an input unit inputting first vibration information observed from a moving body, a generating unit generating second vibration information based on a periodic function including at least one parameter that models periodic motion of the moving body, and an estimating unit estimating the at least one parameter based on a comparison result for the first vibration information inputted by the input unit and the second vibration information generated by the generating unit. The estimating unit repeatedly estimates the at least one parameter based on a comparison result for the first vibration information and the second vibration information that has been regenerated by the generating unit using the estimated at least one parameter.

The first vibration information may be information showing phase variations of the periodic motion of the moving body, the periodic function may be a model showing positional variations of the moving body, and the generating unit may generate the second vibration information by converting information showing positional variations outputted by the periodic function to information showing phase variations.

The first vibration information may be a beat signal obtained by synthesis of a transmitted wave, which is a sound wave or an electric wave, and a reflected wave reflected by the moving body, which is a vibrating body.

The first vibration information may be information showing positional variations of the moving body, the periodic function may be a model showing positional variations of the moving body, and the generating unit may set information showing the positional variations outputted by the periodic function as the second vibration information.

The first vibration information may be information showing acceleration of the moving body, the periodic function may be a model showing positional variations of the moving body, and the generating unit may generate the second vibration information by converting information showing positional variations outputted by the periodic function to information showing acceleration.

The estimating unit may compare standardized waveforms for the first vibration information and the second vibration information.

The first vibration information inputted into the input unit may be information produced by applying an IIR (Infinite Impulse Response) filter to an output of a sensor that observes the moving body, and the generating unit may generate the second vibration information by applying a pseudo IIR filter.

The information processing apparatus may further comprise a state estimating unit estimating a state of the moving body based on a degree of match between the first vibration information and the second vibration information.

The estimating unit may sequentially estimate the at least one parameter using one of a particle filter that has the at least one parameter as particles, a Kalman filter, and an ensemble of a plurality of Kalman filters.

The estimating unit may set at least one out of a mean value, a median value, and a mode value of the at least one parameters included in a plurality of the particles as a representative value.

According to another embodiment of the present invention, there is provided an information processing method which includes inputting first vibration information observed from a moving body, generating second vibration information based on a periodic function including at least one parameter that models periodic motion of the moving body, estimating the at least one parameter based on a comparison result for the inputted first vibration information and the generated second vibration information, and repeatedly estimating the at least one parameter based on a comparison result for the first vibration information and the second vibration information that has been regenerated using the estimated at least one parameter.

According to another embodiment of the present invention, there is provided a recording medium recording a program causing a computer to function as an information processing apparatus that includes an input unit inputting first vibration information observed from a moving body, a generating unit generating second vibration information based on a periodic function including at least one parameter that models periodic motion of the moving body, and an estimating unit estimating the at least one parameter based on a comparison result for the first vibration information inputted by the input unit and the second vibration information generated by the generating unit. The estimating unit repeatedly estimates the at least one parameter based on a comparison result for the first vibration information and the second vibration information that has been regenerated by the generating unit using the estimated at least one parameter.

According to the embodiments of the present invention described above, it is possible to evaluate an arbitrary movement component of a moving body based on an observation result produced by a sensor.

### BRIEF DESCRIPTION OF THE DRAWINGS

FIG. 1 is a block diagram showing the configuration of an information processing apparatus according to a first embodiment;

FIGS. 2A and 2B are diagrams useful in explaining a displacement model according to the first embodiment;

FIG. 3 is a flowchart showing the operation of the information processing apparatus according to the first embodiment;

FIG. 4 is a diagram useful in explaining an experimental environment of the information processing apparatus according to the first embodiment;

FIGS. 5A to 5C are diagrams showing experimental results for the information processing apparatus according to the first embodiment;

FIG. 6 is a diagram showing experimental results for the information processing apparatus according to the first embodiment;

FIGS. 7A to 7F are diagrams showing experimental results for the information processing apparatus according to the first embodiment; and

FIG. 8 is a diagram showing experimental results for the information processing apparatus according to the first embodiment.

### DETAILED DESCRIPTION OF THE EMBODIMENT(S)

Hereinafter, referring to the appended drawings, preferred embodiments of the present invention will be described in detail. It should be noted that, in this specification and the appended drawings, structural elements that have substantially the same function and structure are denoted with the same reference numerals, and repeated explanation thereof is omitted.

### 1. Overview of Information Processing Apparatus According to an Embodiment of the Present Invention

An information processing apparatus according to an embodiment of the present invention evaluates an arbitrary movement component of a moving body based on an observation result produced by a sensor. In more detail, the information processing apparatus applies the framework of a particle filter for an arbitrary periodic function model that describes the displacement of a moving body which performs periodic motion and the output signal waveform of a sensor to directly estimate the parameters included in the periodic function model. The information processing apparatus is capable of evaluating an arbitrary movement component of the moving body using the estimated parameters. The information processing apparatus is also capable of estimating, based on the fit with an output signal waveform of a periodic function model that has used the estimated parameters, whether the movement that is the subject of the periodic function model is present.

Since parameters are sequentially estimated using a particle filter, the information processing apparatus is also capable, for an organism where fluctuations and changes occur in movement such as respiration, of tracking changes and updating the periodic function model. This means that it is possible for the information processing apparatus to sequentially specify parameters and to continually extract the characteristics of movement of the moving body and to continually estimate whether the movement that is the subject of the periodic function model is present.

This completes the description of the overview of the information processing apparatus according to an embodiment of the present invention. Such embodiment will now be described in detail.

### 2. First Embodiment

The information processing apparatus according to the present embodiment is capable of estimating, based on vibration information that has been observed from a moving body which performs periodic motion, the state of the moving body. In the present specification, it is assumed that the information processing apparatus 1 estimates the state of respiratory motion with humans as one example of a moving body and respiratory motion of humans as one example of periodic motion.

### 2-1. Configuration

First, the internal configuration of an information processing apparatus according to this first embodiment will be described.

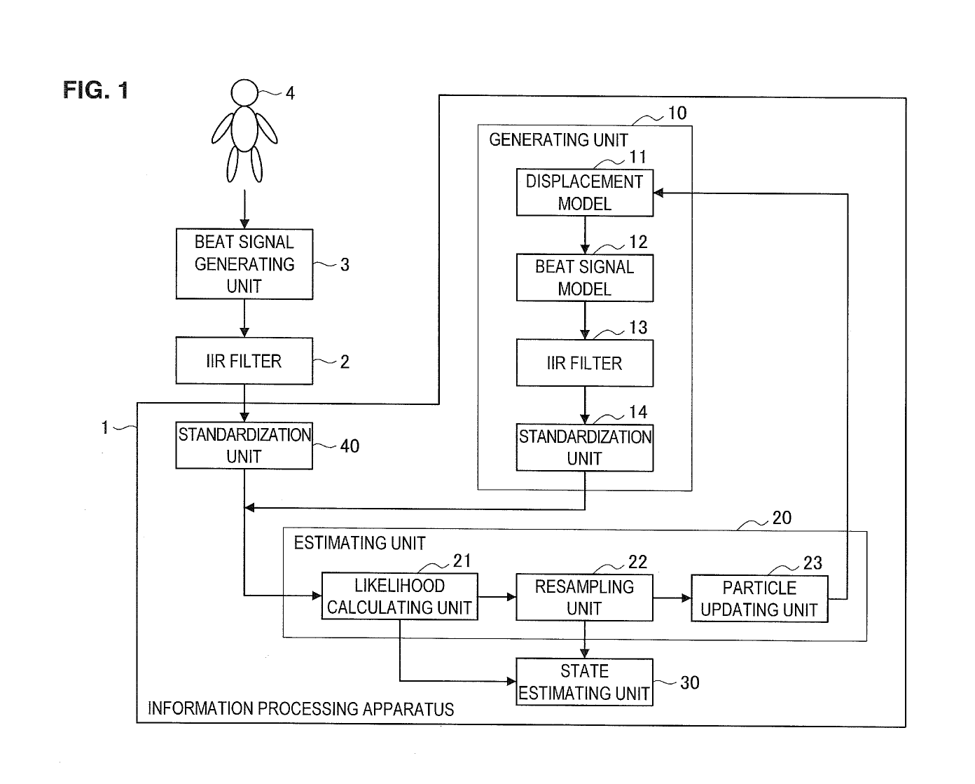

FIG. 1 is a block diagram showing the configuration of the information processing apparatus 1 according to the first embodiment. As shown in FIG. 1, the information processing apparatus 1 includes a generating unit 10, an estimating unit 20, a state estimating unit 30, and a standardization unit 40. The information processing apparatus 1 also receives an input of an observation result produced by a beat signal generating unit 3 observing a person 4 via an IIR (Infinite Impulse Response) filter 2.

### Person 4

The person 4 is an object that reflects electrical waves emitted from the beat signal generating unit 3. The person 4 is also an object that performs periodic motion in the form of respiratory motion. Respiratory motion can be divided into inhalation and exhalation operations, with it being common for the respective speeds of inhalation and exhalation to change differently.

### Beat Signal Generating Unit 3

The beat signal generating unit 3 is a sensor that transmits electrical waves toward the person 4 and receives electrical waves that have been reflected by the person 4, and outputs a beat signal (or “first vibration information”) which is a signal whose frequency is the difference between the transmitted waves and received waves. The beat signal is information showing phase variations in the periodic motion, that is, the respiratory motion of the person 4. Aside from electrical waves, the beat signal generating unit 3 may output a beat signal by transmitting and receiving sound waves, light, or the like. Although it is assumed here that the beat signal generating unit 3 uses continuous waves and quadrature detection and therefore outputs two waves, a sine wave and a cosine wave, as the output signal, instead of using continuous waves, it is also possible to apply a sweep-type method where the frequency is changed within a range of frequencies in certain intervals or a frequency-switching method where the frequency is switched at certain intervals. Such output signals are expressed by the following expression in the form of complex numbers.

$$\begin{matrix}Math . 1 & \\ D ( t ) = A ( t ) exp [ - j ( \frac{4 π}{λ} ( x ( t ) + {d}_{0} ) + {φ}_{0} ) ] & Equation 1\end{matrix}$$

It is assumed there that A(t) is the amplitude [in V], j is an imaginary number, λ, is the wavelength (in m) of the carrier wave, x(t) is the displacement (in m) of the irradiated object, d₀ is the initial distance (in m), and φ₀ is the initial phase (in rad). Here, the amplitude A(t) includes a DC component and a noise component.

### IIR Filter 2

The IIR filter 2 is an infinite impulse response filter configured inside an analog circuit, and applies an IIR filter to the output from the beat signal generating unit 3 that observes the person 4. In the present specification, it is assumed that the IIR filter 2 is a first-order IIR high pass filter. As mentioned above, although the beat signal includes a DC component, the presence of such DC component can cause failures or signal saturation when extracting phase parts where the displacement to be measured is given. For this reason, the information processing apparatus 1 removes the DC component using the IIR filter 2. Although it is also possible to use a configuration with no filter if the offset voltage of the beat signal generating unit has been correctly compensated or removed, it is important to use a method that enables the calculation for estimating a pseudo beat signal to be carried out. Although the IIR filter 2 modulates the amplitude and phase in a nonlinear manner according to the frequency of the input signal, the IIR filter 2 is capable of removing a DC component. The IIR filter 2 removes the DC component from the beat signal shown in Equation 1 given above and output the signal shown by the following expression.

$$\begin{matrix}Math . 2 & \\ {D}_{f} ( t ) = A ( t ) {f}_{r} ( t ) exp [ - j ( \frac{4 π}{λ} ( x ( t ) + {d}_{0} ) + {φ}_{0} + {f}_{φ} ( t ) ) ] & Equation 2\end{matrix}$$

It is assumed here that the influence that an IIR high pass filter implemented in an analog circuit has on amplitude is fᵣ(t) and that the influence on phase is f_{φ}(t).

The IIR filter 2 outputs a beat signal that has been subjected to signal processing to the information processing apparatus 1.

### Standardization Unit 40

The standardization unit 40 has a function of standardizing the beat signal outputted from the IIR filter 2. More specifically, it is assumed that the standardization unit 40 standardizes the beat signal to a mean value of 0 and a standard deviation of 1. Note that the standardization unit 40 can also be regarded as an input unit that inputs the beat signal.

### Generating Unit 10

The generating unit 10 has a function of artificially generating, based on a periodic function including at least one parameter produced by modelling periodic motion of the person 4, a beat signal expected to be outputted when periodic motion of the modelled person 4 is observed by the beat signal generating unit 3. Such beat signal artificially generated by the generating unit 10 is also referred to as the “pseudo beat signal” or “the second vibration information”. The generating unit 10 includes functions as a displacement model 11, a beat signal model 12, an IIR filter 13, and a standardization unit 14.

### Displacement Model 11

The displacement model 11 is a periodic function including at least one parameter produced by modelling periodic motion of the person 4. More specifically, the displacement model 11 is a periodic function produced by modelling changes in displacement (information showing positional variations) of the chest wall due to respiration of the person 4, and is r(t) shown in Equation 4 given later. Before describing the displacement model of the chest wall according to the present embodiment, first a comparative example of a displacement model of the chest wall will be described.

The model s(t) shown by the following equation is one comparative example of a periodic function produced by modelling displacement of the chest wall (see Y. Seppenwoolde, H. Shirato, K. Kitamura, S. Shimizu, M. van Herk, J. V. Lebesque, and K. Miyasaka, “Precise and real-time measurement of 3D tumor motion in lung due to breathing and heartbeat, measured during radiotherapy,” International Journal of Radiation Oncology* Biology* Physics, vol. 53, no. 4, pp. 822-834, 2002).

Math. 3

s(t)=V cos²ⁿ(πft−θ)+d₀ Equation 3

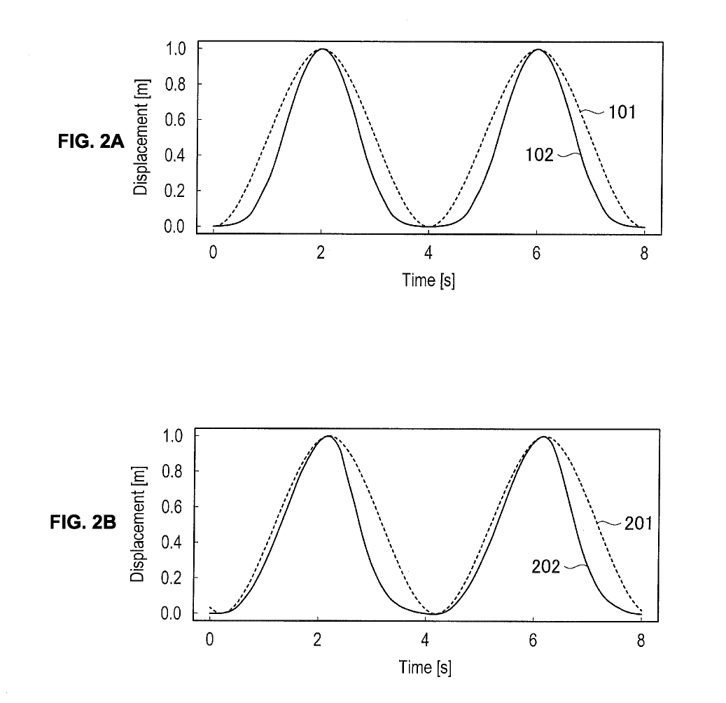

Here, V(≧0) is the maximum displacement (in m), f(≧0) is the respiration frequency (in Hz), θ (where 0≦θ≦2π) is the respiration initial phase (in rad), and n(≧1) is a shape change parameter (a non-negative integer). It is assumed here that there is an inhaling motion when s(t) increases and an exhaling motion when s(t) decreases. FIG. 2A shows an example shape change when the parameters aside from the parameter n are fixed (V=1.00, f=0.25, θ=−π/2). Note that FIGS. 2A and 2B are diagrams useful in explaining a displacement model according to the first embodiment. Numeral 101 is s(t) in a case where n=1, and numeral 102 is s(t) in a case where n=2. As shown in FIG. 2A, as n increases, the change in speed increases.

In this comparative example, there are two constraints. The first constraint is that during respiratory motion, the change in speed is the same for inhalation and exhalation. As mentioned earlier, although there is normally the possibility for the change in speed to differ between inhalation and exhalation due to individual differences, the comparative example given here does not consider this point. The second constraint is that the shape change parameter n that controls the variation in speed is an integer. Since the comparative example uses only integers as n, it is difficult to carry out precise control over the change in speed. However, periodic oscillation that is a vital activity of a living body, such as human respiration, exhibits many slight distortions in waveform between individuals, and it is rare for the outward and inward motion in such oscillation to be symmetrical.

For this reason, the present embodiment overcomes such constraints with the comparative example and proposes a displacement model r(t) for the chest wall shown by the following expression where asymmetrical motion in the outward and inward directions of the oscillation can be defined by parameters.

$$\begin{matrix} Math . 4 & \\ r ( t ) = V ( \frac{1 - exp [ η {sin}^{2} ( π f t - θ ) ]}{1 - exp [ η ]} ) + {d}_{0} \{ \begin{matrix}η = α , sin ( 2 π f t + 2 θ ) > 0 \\ η = β , sin ( 2 π f t + 2 θ ) \leq 0\end{matrix} & Equation 4\end{matrix}$$

In the same way as the comparative example s(t), it is assumed here that there is an inhaling motion when r(t) increases and an exhaling motion when r(t) decreases. That is, when α(>0), this expresses a change in the speed of inhalation, while when β (>0), this expresses a change in the speed of exhalation. In the following description, r(t) is also referred to as the “respiration displacement model”.

By including the independent parameters α and β, the respiration displacement model r(t) is capable of expressing changes in speed when the change in speed is not the same for inhalation and exhalation. Although a split is set in the respiration displacement model r(t) regarding η, since the model is designed so as to definitely pass the node r(t)=0 and the node r(t)=V in either case, the model can be regarded as a continuous periodic function in pieces.

Here, FIG. 2B shows an example shape change for a case where the parameters aside from the parameters α and β are fixed (V=1.00, f=0.25, 0=0.00). Numeral 201 is a respiration displacement model r(t) for a case where the shape change parameter is (α=0.10, β=0.10). In the same way as the comparative example s(t), the respiration displacement model r(t) in this case assumes that the change in speed is the same for inhalation and exhalation. Meanwhile, numeral 202 is a respiration displacement model r(t) for a case where the shape change parameter is (α=0.75, (β=3.25). The respiration displacement model r(t) in this case expresses a case where the change in speed is large for exhalation compared to inhalation.

In this way, the respiration displacement model r(t) is capable of expressing a case where the change in speed is different between inhalation and exhalation. In addition, since the shape change parameters α and β can take positive real numbers that are not integers, it can be said that the respiration displacement model r(t) is more capable of expressing respiration displacements compared to the comparative example s(t).

The displacement model 11 outputs the change in displacement of the chest wall to the beat signal model 12.

### Beat Signal Model 12

The beat signal model 12 carries out processing that transforms changes in the displacement of the chest wall (i.e., information showing positional variations) outputted from the displacement model 11 to a beat signal expression (i.e., information showing phase variations). That is, the beat signal model 12 has a function of converting changes in the chest wall of a pseudo person expressed by the displacement model 11 to a pseudo beat signal expected to be outputted when observation has been carried out by the beat signal generating unit 3. More specifically, the beat signal model 12 is defined by the following expression as a beat signal model R(t) that has the respiration displacement model r(t) as an input.

$$\begin{matrix} Math . 5 & \\ R ( t \vert V , α , β , f , θ , φ ) = exp [ - j ( \frac{4 π}{λ} r ( t \vert V , α , β , f , θ ) + φ ) ] & Equation 5\end{matrix}$$

In Math. 5 given above, to clearly indicate that φ (where 0≦φ<2π) has been newly added to the parameters that control the model, the notation R(t|•), r(t|•) is used. Here, φ is a phase parameter that has a proportional relationship with the initial distance d₀ and is given by θ∝−(4πd₀/λ+φ₀) in Equation 1 given earlier. Math. 5 above also does not consider the amplitude. This is because amplitude has hardly any effect on the processing by the IIR filter 13.

The beat signal model 12 outputs the generated pseudo beat signal to the IIR filter 13.

IIR filter 13

The IIR filter 13 is an infinite impulse response filter configured as a digital filter and applies a pseudo IIR filter to the pseudo beat signal outputted from the beat signal model 12. In the present specification, the IIR filter 13 is assumed to be an IIR Butterworth high-pass filter. The IIR filter 13 is a pseudo digital filter that simulates the properties of the IIR filter 2. The beat signal outputted from the beat signal generating unit 3 is subjected to signal processing by the IIR filter 2 implemented by an analog circuit. In the same way, the pseudo beat signal outputted from the beat signal model 12 is subjected to signal processing by the IIR filter 13 that simulates the properties of the IIR filter 2. The pseudo beat signal after signal processing by the IIR filter 13 is defined by the following expression.

$$\begin{matrix}Math . 6 & \\ {R}_{f} ( t ) = {f}_{r}^{′} ( t ) exp [ - j ( \frac{4 π}{λ} r ( t ) + φ + {f}_{φ}^{′} ( t ) ) ] & Equation 6\end{matrix}$$

Here, it is assumed that the influence that an IIR Butterworth high pass filter has on amplitude is f′r(t) and that the influence on phase is f′φ(t). The pseudo beat signal Rf(t) is referred to below as the “respiratory model”.

### Standardization Unit 14

The standardization unit 14 has a function of standardizing the pseudo beat signal outputted from the IIR filter 13. More specifically, in the same way as the standardization unit 40, it is assumed that the standardization unit 14 standardizes the pseudo beat signal to a mean value of 0 and a standard deviation of 1.

### Estimating Unit 20

The estimating unit 20 has a function of estimating parameters of a model used by the generating unit 10 based on a comparison result for the beat signal outputted from the standardization unit 40 and the pseudo beat signal generated by the generating unit 10. The estimating unit 20 sequentially estimates the parameters. Distortion due to micro asymmetry or the like in the movement of the living body is absorbed by the model and distortion due to long-term variations in movement is dynamically followed and absorbed through sequential estimation. In more detail, the estimating unit 20 repeatedly estimates parameters based on a comparison result for the pseudo beat signal that is regenerated by the generating unit 10 using the estimated parameters and the beat signal outputted from the standardization unit 40.

More specifically, the estimating unit 20 uses a particle filter, which can be applied even when the parameters are high-dimensional and differentiation is not possible, to sequentially extract the distribution of the six parameters (V, α, β, f, θ, φ). As described earlier, even though the IIR filter modulates amplitude and phase non-linearly according to the frequency of the input signal, a particle filter is capable of solving non-linear state equations. When the observed values up to the present time t are expressed as Yₜ={y₀, . . . , yₜ} and the state variable is xₜ, a particle filter is a method of sequentially estimating the posterior distribution (xₜ|Yₜ) using the recurrence formula shown in expression 7 and expression 8 below.

$$\begin{matrix}Math . 7 & \\ p ( {x}_{t} \vert {Y}_{t - 1} ) = \int p ( {x}_{t} \vert {x}_{t - 1} ) p ( {x}_{t - 1} \vert {Y}_{t - 1} ) d {x}_{t - 1} & Equation 7 \\ Math . 8 & \\ p ( {x}_{t} \vert {Y}_{t} ) = \frac{p ( {y}_{t} \vert {x}_{t} ) p ( {x}_{t} \vert {Y}_{t - 1} )}{\int p ( {y}_{t} \vert {x}_{t} ) p ( {x}_{t} \vert {Y}_{t - 1} ) d {x}_{t}} & Equation 8\end{matrix}$$

Note that if the density distribution of xt is expressed by a set of discrete particles according to a Monte Carlo approximation, it will be possible to approximately calculate Equation 7 and Equation 8.

Here, the estimating unit 20 configures a state-space model of a particle filter with the parameters used in the generating unit 10 as single particles. First, the number of particles is set as i (where i=1, . . . , m) and a k^{th} (where k=1, . . . , K) complex observation vector that has been cut out in a time window of length N from the beat signal D_{f}(t) inputted into the information processing apparatus 1 is set as yₖ. Also, a complex model vector of length N generated from the respiratory model R_{f}(t|xₖ⁽ⁱ⁾) is set as mₖ⁽ⁱ⁾.

Here, yₖ is standardized by the standardization unit 40 and mₖ⁽ⁱ⁾ is standardized by the standardization unit 14 so that the respective mean values are 0 and the standard deviations are 1. This means that it is possible for the generating unit 10 to compare yₖ and mₖ⁽ⁱ⁾ using standardized waveforms. That is, since it becomes possible for the generating unit 10 to compare phase changes, which are relative changes, regardless of amplitude, the estimation precision for parameters will not depend on the distance between the beat signal generating unit 3 and the person 4 and it will be possible to estimate even when the distance is large.

Next, the state vector is defined as xₖ=[Vₖ, αₖ, βₖ, fₖ, θₖ, φₖ]^{T} and the system noise vₖ is defined as v_{k˜}[N(0,σᵥ), N(0,σ_{α}), N(0,σ_{β}), N(σ_{f}), vM(0,σ_{θ}), vM(0,σ_{φ})]^{T}. N(•) indicates a normal distribution, while vM (•) indicates a von Mises distribution. A von Mises distribution is a distribution defined on a circumference and can be said to be appropriate for expressing phase. Note that although it would be conceivable to use a Kalman filter as another method of sequential estimation, since a Kalman filter has a premise of a normal distribution, adoption is difficult for a von Mises distribution. Meanwhile, since the estimating unit 20 according to the present embodiment estimates according to a particle filter, it is possible to use a von Mises distribution.

Here, the estimating unit 20 functions as a likelihood calculating unit 21, a resampling unit 22, and a particle updating unit 23. The likelihood calculating unit 21, the resampling unit 22, and the particle updating unit 23 carry out parameter estimation according to a particle filter that has state vectors xₖ as particles.

### Particle Updating Unit 23

The particle updating unit 23 has a function of updating the particles of a particle filter. The particles updated by the particle updating unit 23 are defined by the following equation.

Math. 9

xₖ⁽ⁱ⁾=xₖ₋₁⁽ⁱ⁾+vₖ₋₁⁽ⁱ⁾ Equation 9

The particle updating unit 23 updates to a particle xₖ⁽ⁱ⁾ for the present time using xₖ₋₁⁽ⁱ⁾ that was resampled by the resampling unit 22, described later, at the immediately preceding time. Note that it is also possible to regard the Equation 9 as a system model of the particle filter.

The particle updating unit 23 inputs parameters including the updated particles into the displacement model 11. The generating unit 10 generates a pseudo beat signal based on the inputted parameters and outputs the generated pseudo beat signal to the likelihood calculating unit 21.

### Likelihood Calculating Unit 21

The likelihood calculating unit 21 has a function of calculating the likelihood of the particle xₖ⁽ⁱ⁾ that has been updated by the particle updating unit 23. In more detail, the likelihood calculating unit 21 calculates the likelihood by comparing a beat signal and a pseudo beat signal according to the same conditions, that is, by comparing after the application of an IIR filter and standardization for both signals. An observation model for the likelihood calculated by the likelihood calculating unit 21 is defined by the following expression.

$$\begin{matrix}Math . 10 & \\ p ( {y}_{k} \vert {x}_{k}^{( i )} ) = \frac{1}{\sqrt{2 π} {σ}_{o}} exp [ - \frac{{( {y}_{k} - {m}_{k}^{( i )} )}^{H} ( {y}_{k} - {m}_{k}^{( i )} )}{2 {σ}_{o}^{2}} ] & Equation 10\end{matrix}$$

Here, it is assumed that σo is the variance of the observation noise, and H is the conjugate transpose symbol. The likelihood calculating unit 21 outputs the calculated likelihood to the resampling unit 22 and the state estimating unit 30.

### Resampling Unit 22

The resampling unit 22 has a function of resampling particles based on the likelihood calculated by the likelihood calculating unit 21. Out of the particles updated by the particle updating unit 23, the probability of the resampling unit 22 obtaining each particle is defined by the following expression from the observation model shown in Equation 10 and the Monte Carlo approximation expression shown in Equation 8.

$$\begin{matrix}Math . 11 & \\ {w}_{k}^{( i )} = \frac{p ( {y}_{k} \vert {x}_{k}^{( i )} )}{{\sum }_{i = 1}^{m} p ( {y}_{k} \vert {x}_{k}^{( i )} )} & Equation 11\end{matrix}$$

The estimating unit 20 outputs an expected value of each parameter distribution that has been resampled as the parameter estimated value \hat{x} for that time. When doing so, the estimating unit 20 uses at least one of a mean value, a median value, or a mode value of the parameters included in a plurality of particles as representative values and outputs such representative values as the estimated value \hat{x}. The estimating unit 20 is capable of changing the representative values in accordance with the form of the distribution so that as examples, mean values are used for a parameter distribution that is a normal distribution, median values are used for a geometric distribution, and mode values are used for other distributions. By repeating such processing, when the beat signal correctly reflects the state of the living body, a result will be obtained where the pseudo beat signal dynamically follows the beat signal which may include a long term variation component due to long term variations in the living body.

### State Estimating Unit 30

The state estimating unit 30 has a function of estimating the state of the person 4 based on the degree of match between the beat signal and the pseudo beat signal. More specifically, the state estimating unit 30 estimates the state of the person 4 based on the likelihood outputted by the likelihood calculating unit 21. As one example, the state estimating unit 30 estimates that the person 4 who is performing respiratory motion is present in a wave range of the beat signal generating unit 3 if the likelihood is high and that the person 4 is not present if the likelihood is low. This is because although a respiratory model will generate a pseudo beat signal with the highest precision when generating based on motion due to respiration, such model will not be able to follow a signal in cases aside from respiration, such as random noise, and the difference between the pseudo beat signal and the actual beat signal will increase. In addition to the above, the state estimating unit 30 may estimate the state of the person 4 based on parameter estimated values outputted from the resampling unit 22. As one example, according to α that sets the change in speed during inhalation and β that sets the change in speed during exhalation, it is possible to separately evaluate the movement components during inhalation and exhalation by the person 4. The information processing apparatus 1 expresses periodic motion of a moving body using a model including parameters, such as the respiration displacement model r(t) shown in Equation 4, and by estimating such parameters, it is possible to evaluate an arbitrary movement component within the wave range of the beat signal generating unit 3. The state estimating unit 30 is also capable of determining whether an abnormality has occurred in the state of the person 4 or the like according to the time series variation, magnitudes and the like of α and β.

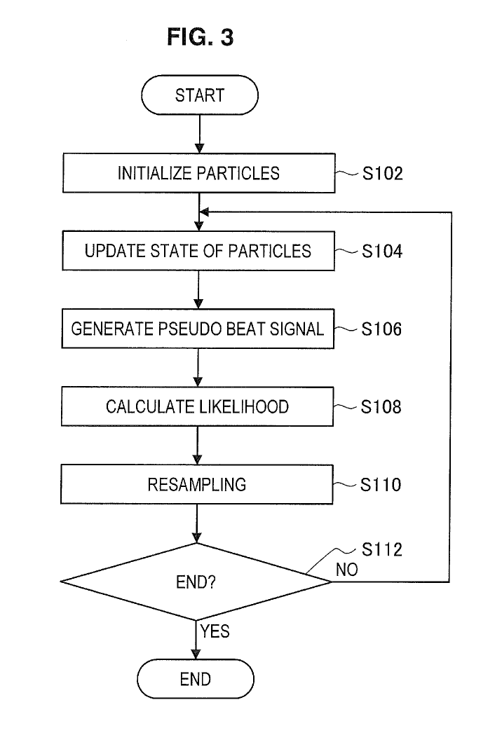

This completes the description of the configuration of the information processing apparatus 1 according to the present embodiment. Next, the operation of the information processing apparatus 1 according to the present embodiment will be described with reference to FIG. 3.

### 2-2. Operation Processing

FIG. 3 is a flowchart showing the operation of the information processing apparatus 1 according to the first embodiment. As shown in FIG. 3, first in step S102, the information processing apparatus 1 initializes the particles. More specifically, the particle updating unit 23 provides the initial value x₀ of the state vector xₖ and the initial value v₀ of the system noise vₖ.

Next, in step S104, the information processing apparatus 1 updates the state of the particles. More specifically, the particle updating unit 23 updates the particles according to Equation 9 above.

After this, in step S106, the information processing apparatus 1 generates a pseudo beat signal. In more detail, first the displacement model 11 defines the respiration displacement model r(t) according to Equation 4 based on the parameters updated by the particle updating unit 23. The beat signal model 12 then generates a pseudo beat signal according to Equation 5, the IIR filter 13 applies an IIR filter, and the standardization unit 14 carries out standardization.

Next, in step S108, the information processing apparatus 1 calculates the likelihood. In more detail, the likelihood calculating unit 21 calculates the likelihood that is shown in Equation 10 by comparing the beat signal that was outputted by the beat signal generating unit 3, has had an IIR filter applied by the IIR filter 2, and has been standardized by the standardization unit 40 and the pseudo beat signal outputted from the generating unit 10.

After this, in step S110, the information processing apparatus 1 resamples the particles. In more detail, the resampling unit 22 resamples the particles according to Equation 11 based on the likelihood calculated by the likelihood calculating unit 21.

Next, in step S112, the information processing apparatus 1 determines whether to end the processing. If the processing is not to end (S112/NO), the information processing apparatus 1 repeats the steps S104 to S110 again to sequentially estimate parameters. If the processing is to end (S112/YES), the information processing apparatus 1 ends the processing.

Note that although not indicated in FIG. 3, the information processing apparatus 1 may estimate the state of the person 4 as appropriate. More specifically, the state estimating unit 30 may sequentially estimate the state of the person 4 based on the likelihood outputted by the likelihood calculating unit 21 in step S110 described above and the parameter estimated values outputted by the resampling unit 22.

This completes the description of the operation of the information processing apparatus 1 according to the present embodiment.

### 2-3. Modification

Although in the above description, the information processing apparatus 1 estimates the state of the person 4 based on an observation result produced by the beat signal generating unit 3, the present invention is not limited to such example. As another example, the information processing apparatus 1 may estimate the state of the person 4 based on an observation result of another sensor, such as a sensor that measures distance or an acceleration sensor.

More specifically, the information processing apparatus 1 compares an output value from a model and an output value from a sensor by converting information showing positional variations of a living body outputted from the displacement model 11 in accordance with the type of information outputted from the sensor. As one example, in the present embodiment, since the output from the beat signal generating unit 3 is information showing phase variations, the information processing apparatus 1 converts information showing the positional variations of the moving body outputted from the displacement model 11 into information showing phase variations according to the beat signal model 12 and then compares the information. Conversion methods for cases where a sensor that measures distance and an acceleration sensor are used are described below as examples of where a sensor aside from the beat signal generating unit 3 is used.

First, an example where a distance-measuring sensor is used will be described. A distance-measuring sensor is a sensor that measures the distance from a moving body and outputs information (first vibration information) showing variations in the distance, that is, positional variations of the moving body. In this case, since the output from the displacement model 11 is also information showing position variations, the generating unit 10 outputs the respiration displacement model r(t) shown in Equation 4 described above with no conversion at all as the information to be compared (the second vibration signal). By comparing the output from the distance-measuring sensor and the respiration displacement model r(t) using a particle filter or the like, the information processing apparatus 1 is capable of estimating parameters and estimating the state of the person 4.

Next, the case where an acceleration sensor is used will be described. An acceleration sensor is a sensor that measures the acceleration of a moving body and outputs information (first vibration information) showing the measured acceleration of the moving body. In this case, the generating unit 10 outputs a signal produced by second-order differentiation of the respiration displacement model r(t) shown in Equation 4 above with respect to time t to convert to information showing acceleration as the data to be compared (the second vibration information). By comparing the output from the acceleration sensor and the signal produced by second-order differentiation of the respiration displacement model r(t) using a particle filter or the like, the information processing apparatus 1 is capable of estimating parameters and estimating the state of the person 4. Aside from this, by converting to a displacement signal by second-order differentiation with respect to time t of information showing the acceleration outputted from the acceleration sensor, the information processing apparatus 1 may compare with information showing the displacement outputted by the respiration displacement model r(t).

This completes the description of modifications to the information processing apparatus 1 according to the present embodiment.

### 3. Experimental Results

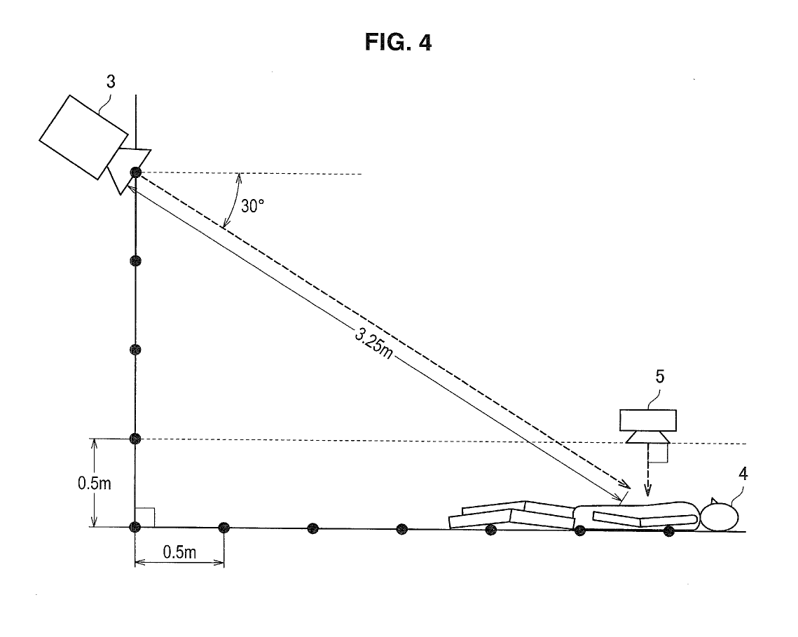

Next, an example of experimental results of experiments carried out to verify the effectiveness of the information processing apparatus 1 according to the present embodiment will be described with reference to FIGS. 4 to 8.

### 3-1. Experimental Environment

FIG. 4 is a diagram useful in explaining the experimental environment of the information processing apparatus 1 according to the first embodiment. As shown in FIG. 4, the beat signal generating unit 3 is mounted on a wall and is observing the person 4. In the experiments, a 24 GHz continuous-wave-type microwave Doppler radar (DSU v1.0) made by Oki Electric Industry Co., Ltd. was used as the beat signal generating unit 3. As shown in FIG. 4, the beat signal generating unit 3 is disposed at a position with a height of 2.00 m and with a depression angle of 30°, and the (horizontal) distance from the chest of the person 4 to directly below the antenna of the beat signal generating unit 3 is around 2.81 m. As shown in FIG. 4, the distance between the beat signal generating unit 3 and the person 4 is around 3.25 m, so that in this experimental environment, it is possible to verify the effectiveness for a state where the distance between the beat signal generating unit 3 and the person 4 is long (>3.0 m). Also, the person 4 is in a supine position. This experimental environment is designed so that the beat signal generating unit 3 looks down on the person 4 because this is assumed to be an actual monitoring environment.

In addition, in this experimental environment, a displacement sensor 5 is disposed so as to face the chest of the person 4 from a height of 0.5 m. In the experiments, a laser displacement sensor (CD-5) made by Optex FA Co., Ltd. was used as the displacement sensor 5. The displacement sensor 5 is capable of using laser light to measure the displacement of a circular area with a diameter of 1 mm with high precision (to the order of μm). In the experiments, measurement by the displacement sensor 5 is carried out together with measurement by the beat signal generating unit 3 and the effectiveness of the information processing apparatus 1 was evaluated based on the measurement results of the displacement sensor 5.

The experiments were conducted for an unmanned state (O) and six healthy adult male subjects (A, B, C, D, E, and F). The measurement time was ten minutes and all of the measuring equipment carried out sampling at 500 Hz. Here, N=4000, m=500, σᵥ=0.0001, σ_{α}=0.5, σ_{β}=0.5, σ_{f}=0.05, σ_{θ}=5.0, σ_{φ}=8.0, and σₒ=5.0 were given as the given parameters of the information processing apparatus 1. The movement width of the time window was also set at 250 samples (K=1184).

### 3-2. Evaluation Method

In this experiment, the experiment results were evaluated using the two evaluation standards below.

### Maximum Log-Likelihoods

Firstly, for these experiments, the experimental results were evaluated using the Maximum Log-Likelihoods Lₖ shown in the following expression.

$$\begin{matrix}Math . 12 & \\ {L}_{k} = {max}_{i} [ log p ( {y}_{k} \vert {x}_{k}^{( i )} ) ] & Equation 12\end{matrix}$$

Lₖ expresses the log likelihood of a particle with the best match at time k. Using such value, it is possible to evaluate the presence of respiration based on the output of the beat signal generating unit 3

### Correlations Using a Displacement Sensor

Secondly, for these experiments, the experimental results were evaluated using an output vector dₖ of the displacement sensor 5 and a correlation value Cₖ calculated by the displacement respiration model r(t|\hat{x}ₖ) that has been provided with parameters estimated by the estimating unit 20. If the displacement model is expressed as a vector as rₖ, the correlation value Cₖ is expressed by the following expression.

$$\begin{matrix}Math . 13 & \\ {C}_{k} = \vert \frac{{( {d}_{k} - 𝔼 [ {d}_{k} ] )}^{T} ( {r}_{k} - 𝔼 [ {r}_{k} ] )}{\sqrt{𝕍 [ {d}_{k} ] 𝕍 [ {r}_{k} ]}} \vert & Equation 13\end{matrix}$$

According to such value, it is possible to estimate whether the respective parameters estimated by the estimating unit 20 are capable of expressing the true respiration displacement.

### 3-3. Experimental Results

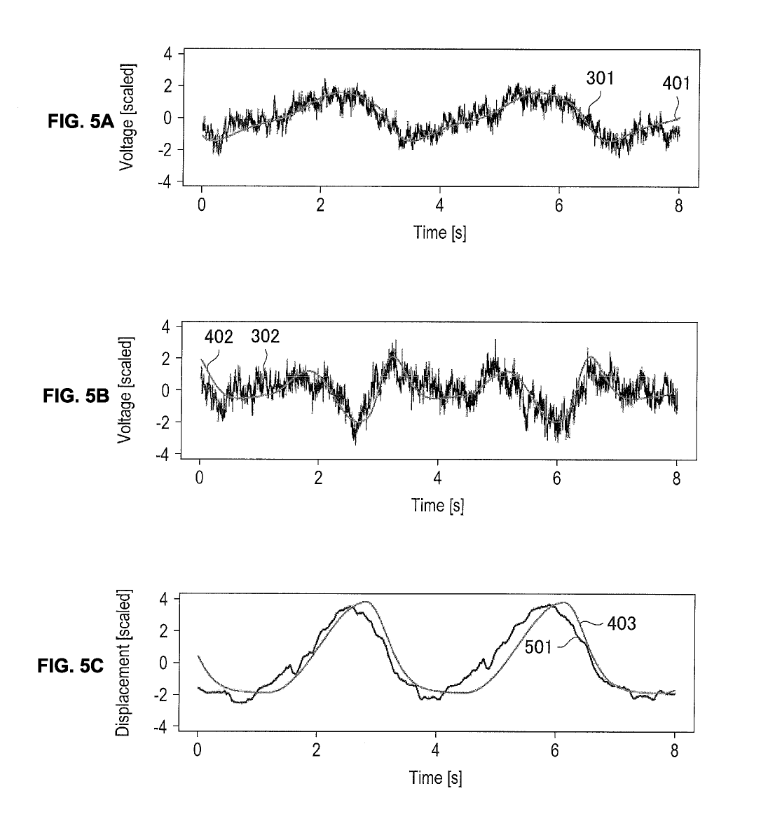

Next, the experimental results in the experimental environment described above will be described with reference to FIGS. 5A to 8. FIGS. 5A to 8 are diagrams showing the experimental results of the information processing apparatus 1 according to the first embodiment.

In FIGS. 5A to 5C, comparison results for measurement results and estimation results are shown. In more detail, FIGS. 5A and 5B shows the output signal from the beat signal generating unit 3 (the beat signal D_{f}(t) that has been standardized by the standardization unit 40) and the estimated model signal (the respiratory model R_{f}(t) that has been standardized by the standardization unit 14). In more detail, in FIG. 5A, the real part of the output signal is shown by the numeral 301 and the real part of the model signal is shown by the numeral 401. In FIG. 5B, the imaginary part of the output signal is shown by the numeral 302 and the imaginary part of the model signal is shown by the numeral 402. The estimated parameters are (V=0.0017, α=0.21, β=4.51 m, F=0.30, θ=0.71, φ=2.27), the maximum likelihood Lₖ=77.70, and the correlation value=0.93. Also, in FIG. 5C, the output signal of the displacement sensor 5 is shown by numeral 501 and the displacement shown by the displacement respiration model r(t|\hat{x}ₖ) that has been provided with the estimated parameters is shown by numeral 403.

Next, aggregated results of the mean values and the standard deviations of respective estimated parameters are shown in Table 1 below. However, since θ and φ are phase parameters, such parameters are not represented. The subject “O” shows an unmanned state, while “A” to “F” show manned states and are the results obtained from the subjects “A” to “F”. As shown in Table 1, large values were obtained for the parameters of the unmanned state “O” compared to the manned states “A” to “F”.

TABLE 1

| | Mean ± Sd | | | |
|---|---|---|---|---|
| Subject | V [mm] | α | β | f [Hz] |
| O | 2.07 ± 0.77 | 9.33 ± 6.37 | 8.39 ± 4.60 | 0.35 ± 0.27 |
| A | 1.14 ± 0.70 | 4.88 ± 3.17 | 4.24 ± 3.47 | 0.23 ± 0.07 |
| B | 1.09 ± 0.90 | 2.91 ± 2.57 | 3.70 ± 3.76 | 0.29 ± 0.06 |
| C | 1.46 ± 1.37 | 2.71 ± 2.44 | 1.59 ± 1.54 | 0.32 ± 0.08 |
| D | 0.98 ± 0.54 | 0.79 ± 1.25 | 0.77 ± 1.13 | 0.28 ± 0.04 |
| E | 0.57 ± 0.48 | 2.22 ± 2.03 | 4.43 ± 3.25 | 0.21 ± 0.11 |
| F | 2.11 ± 0.79 | 1.77 ± 2.18 | 3.21 ± 3.00 | 0.22 ± 0.06 |

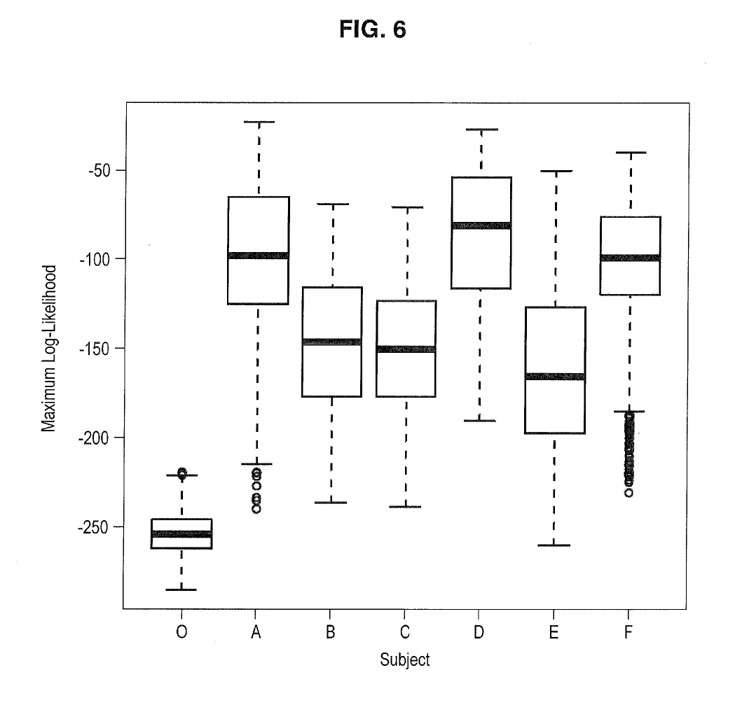

In FIG. 6, a box plot showing the variation in the distribution of the maximum log-likelihood Lₖ of each subject is shown. The horizontal axis in FIG. 6 shows each subject and the vertical axis shows the value of the maximum log-likelihood Lₖ. Here, as a result of carrying out a Welch two-sample t-test (H₀:μ₁=μ₂, H₁:μ₁≠μ₂) that is capable of testing the difference in mean values without considering the equality of variance between the unmanned state “O” and the respective manned states “A” to “F”, p<0.0001 was given for every combination, indicating significance. Also, as shown in FIG. 6, out of the subjects, distributions where the median value of the maximum log-likelihood Lₖ is −100 or above were obtained for the subjects “A”, “D”, and “F” only.

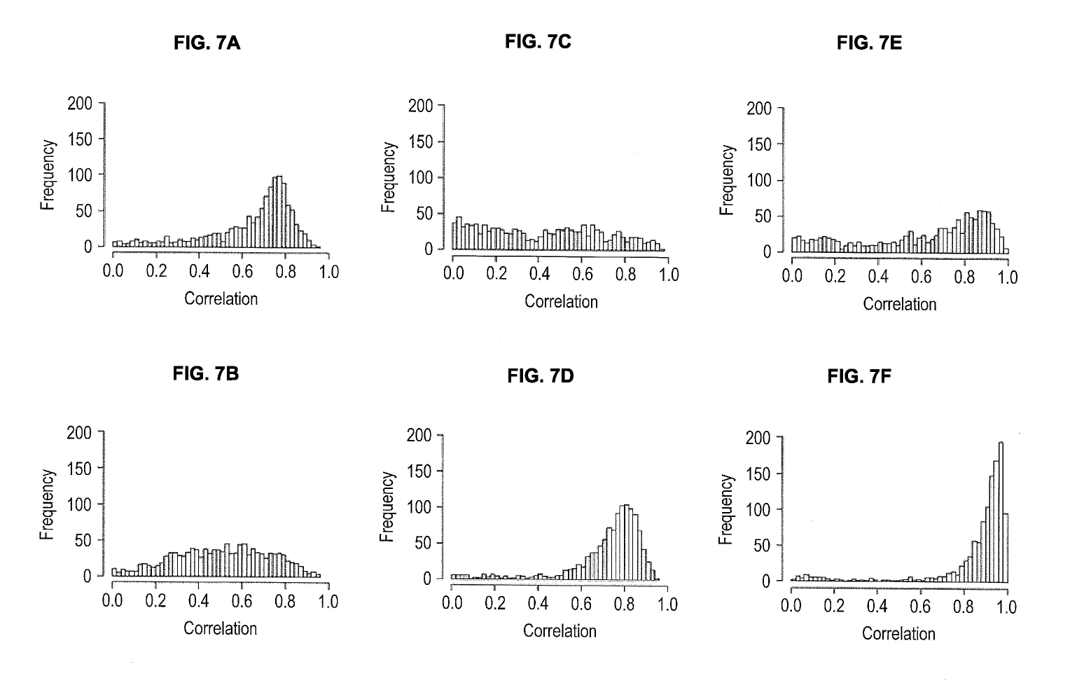

FIGS. 7A to 7F show histograms that express a distribution of the correlation value Cₖ for each subject. That is, FIG. 7A is a histogram of the subject “A” and FIGS. 7B to 7F are the same. In FIGS. 7A to 7F, the vertical axis shows the frequency and the horizontal axis shows the value of the correlation value Cₖ. As shown in FIGS. 7A to 7F, only the subjects “A”, “D”, and “F” have distributions where the frequency has a peak of 100 or higher.

Next, the characteristics of the distributions shown in FIGS. 7A to 7F are shown in Table 2 below. Since a distribution with a trailing shape is observed in FIGS. 7A and 7D and a power distribution is observed in FIG. 7F, median values were used as representative values. Together with the median value, skewness that is a measure of symmetry of the distribution is shown in Table 2. As shown in Table 2, a high correlation value (Ck>0.70) was obtained for the subjects “A”, “D”, “E”, and “F”. However, for the subject “E”, from the skewness value, the tendency for asymmetry is weak and the tail is thick, so that as shown in FIGS. 7A to 7F, the frequency is lower than for other subjects.

TABLE 2

| Subject | Median | Skewness |
|---|---|---|
| A | 0.71 | −1.34 |
| B | 0.51 | −0.16 |
| C | 0.43 | 0.14 |
| D | 0.77 | −2.12 |
| E | 0.71 | −0.71 |
| F | 0.92 | −2.67 |

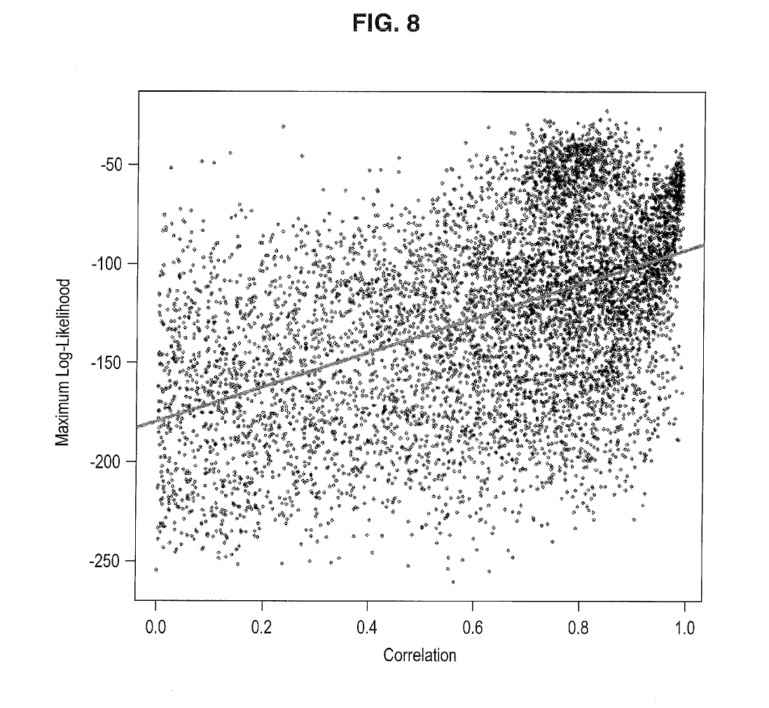

FIG. 8 shows a scatter diagram expressing the relationship between the maximum likelihood Lₖ and the correlation value Cₖ for the subjects “A” to “F”. In FIG. 8, the horizontal axis shows the value of the correlation value Cₖ and the vertical axis shows the value of the maximum likelihood Lₖ. The straight line (Lₖ=−179.295+86.421Cₖ) shown in FIG. 8 is a regression line found by the least squares method. Also, the correlation coefficient of the two variables was ρ=0.48.

### 3-4. Confirmation of Effects

As shown in Table 1, for the subjects “C, “E”, and “F”, the parameter α relating to inhalation and the parameter β relating to exhalation do not match and one mean value is around double the other mean value. Such result suggests that the balance between the inhalation speed and the exhalation speed differs depending on the individual.

As shown in FIG. 6, a large difference was observed in the fluctuation in the distribution of the maximum likelihood Lₖ between the unmanned state “O” and the manned states “A” to “F”. Such difference was confirmed to have a 0.01% significance from the test results of a Welch t test. From these results, it can be said that the likelihood of the respiratory model for data of the unmanned state “O” clearly differs to the likelihood of the manned states “A” to “F”. That is, the information processing apparatus 1 according to the present embodiment is capable of evaluating the state of the person 4, that is, the presence of respiration.

Also, the experimental results of the subjects “A”, “D”, and “F” exhibit correlation distributions where the correlation value is at least 0.7 and the frequency is at least 100, as shown in FIGS. 7A, 7D, and 7F, and in addition exhibit a higher median value (>−100) compared to the subjects “B, “C”, and “E” as shown in FIG. 6. To verify this relationship, the correlation coefficient with a regression line for the two variables as shown in FIG. 8 was found, and as a result positive correlation (p=0.48) was confirmed. From this situation, it can be said that the higher the value of the maximum likelihood Lₖ, the better the real respiration displacement is expressed. That is, the information processing apparatus 1 according to the present embodiment is capable of evaluating the state of the person 4, that is, an arbitrary movement component of the respiration displacement of the person 4 according to parameters with a high maximum likelihood Lₖ.

### 4. Conclusion

As described above, the information processing apparatus 1 according to an embodiment of the present invention is capable of evaluating an arbitrary movement component of a moving body based on an observation result produced by a sensor. More specifically, the information processing apparatus 1 applies the framework of a particle filter for an arbitrary periodic function model that describes the displacement of a moving body which performs periodic motion and the output waveform of a sensor to directly estimate the parameters included in the periodic function model. The information processing apparatus 1 is capable of estimating an arbitrary movement of the moving body according to the estimated parameters and, based on the likelihood of a periodic function model that uses the estimated parameters, is capable of estimating whether the movement that is the subject of the periodic function model is present. Also, since the information processing apparatus sequentially estimates parameters using a particle filter, it is possible to continually estimate whether arbitrary movement components of the moving body and motion that is the subject of the periodic function model is present.

Also, in the experimental results for six subjects carried out at a long distance (3.25 m) at which it is difficult to detect respiration, a clear difference was present between the likelihoods of the unmanned state and the manned states. This shows the effectiveness of the information processing apparatus 1 according to the present embodiment for the problem of detecting respiration. In addition, correlation analysis of the results showed that there is positive correlation for the degree of similarity between the likelihood of the respiration model and the actual respiration displacement obtained from the displacement sensor 5. That is, it was confirmed that the parameter estimated values estimated by the information processing apparatus 1 are capable of favorably representing the actual respiration displacement.

Heretofore, preferred embodiments of the present invention have been described in detail with reference to the appended drawings, but the present invention is not limited thereto. It should be understood by those skilled in the art that various changes and alterations may be made without departing from the spirit and scope of the appended claims.

As one example, although a case where the person 4 who is performing respiratory motion is described in the above embodiment as an example of a moving body that carries out periodic motion, the present invention is not limited to this example. As examples, swinging of the arms when the person 4 walks can be regarded as periodic motion, and the subject may be another type of moving body. Alternatively, the present invention may be applied to vibration of a bridge or a building.

Also, although a configuration where the IIR filter 2 that is configured inside an analog circuit is applied to the output from the beat signal generating unit 3 has been described in the above embodiment, the present invention is not limited to this example. The information processing apparatus 1 may receive a signal produced by applying another filter, such as a band pass filter or a low pass filter to the output from the beat signal generating unit 3. In this case, the information processing apparatus 1 may apply a pseudo digital filter, which simulates the properties of the analog filter that was applied to the output from the beat signal generating unit 3, in place of the IIR filter 13.

Also, although the information processing apparatus 1 has been described in the above embodiment as sequentially estimating parameters using a particle filter, the present invention is not limited to such example. As one example, as the method of sequentially estimating parameters, the estimating unit 20 may analytically estimate using a Kalman filter or the like or use a method such as an ensemble of a plurality of Kalman filters.

It is also possible to produce a computer program for realizing the configurations and the same functions as the information processing apparatus 1 described above on hardware such as a CPU, ROM, and RAM incorporated in an information processing apparatus. A recording medium on which such computer program is recorded is also provided.

What is claimed is:

1. An information processing apparatus comprising:
an input unit inputting first vibration information observed from a moving body;
a generating unit generating second vibration information based on a periodic function including at least one parameter that models periodic motion of the moving body; and
an estimating unit estimating the at least one parameter based on a comparison result for the first vibration information inputted by the input unit and the second vibration information generated by the generating unit,
wherein the estimating unit repeatedly estimates the at least one parameter based on a comparison result for the first vibration information and the second vibration information that has been regenerated by the generating unit using the estimated at least one parameter.

2. The information processing apparatus according to claim 1,
wherein the first vibration information is information showing phase variations of the periodic motion of the moving body,
the periodic function is a model showing positional variations of the moving body, and
the generating unit generates the second vibration information by converting information showing positional variations outputted by the periodic function to information showing phase variations.

3. The information processing apparatus according to claim 2,
wherein the first vibration information is a beat signal obtained by synthesis of a transmitted wave, which is a sound wave or an electric wave, and a reflected wave reflected by the moving body, which is a vibrating body.

4. The information processing apparatus according to claim 1,
wherein the first vibration information is information showing positional variations of the moving body,
the periodic function is a model showing positional variations of the moving body, and
the generating unit sets information showing the positional variations outputted by the periodic function as the second vibration information.

5. The information processing apparatus according to claim 1,
wherein the first vibration information is information showing acceleration of the moving body,
the periodic function is a model showing positional variations of the moving body, and
the generating unit generates the second vibration information by converting information showing positional variations outputted by the periodic function to information showing acceleration.

6. The information processing apparatus according to claim 1,
wherein the estimating unit compares standardized waveforms for the first vibration information and the second vibration information.

7. The information processing apparatus according to claim 1,
wherein the first vibration information inputted into the input unit is information produced by applying an IIR (Infinite Impulse Response) filter to an output of a sensor that observes the moving body, and
the generating unit generates the second vibration information by applying a pseudo IIR filter.

8. The information processing apparatus according to claim 1,
wherein the information processing apparatus further comprises a state estimating unit estimating a state of the moving body based on a degree of match between the first vibration information and the second vibration information.

9. The information processing apparatus according to claim 1,
wherein the estimating unit sequentially estimates the at least one parameter using one of a particle filter that has the at least one parameter as particles, a Kalman filter, and an ensemble of a plurality of Kalman filters.

10. The information processing apparatus according to claim 9,
wherein the estimating unit sets at least one out of a mean value, a median value, and a mode value of the at least one parameters included in a plurality of the particles as a representative value.

11. An information processing method comprising:
inputting first vibration information observed from a moving body;
generating second vibration information based on a periodic function including at least one parameter that models periodic motion of the moving body;
estimating the at least one parameter based on a comparison result for the inputted first vibration information and the generated second vibration information; and
repeatedly estimating the at least one parameter based on a comparison result for the first vibration information and the second vibration information that has been regenerated using the estimated at least one parameter.

12. A recording medium recording a program causing a computer to function as an information processing apparatus that includes:
an input unit inputting first vibration information observed from a moving body;
a generating unit generating second vibration information based on a periodic function including at least one parameter that models periodic motion of the moving body; and
an estimating unit estimating the at least one parameter based on a comparison result for the first vibration information inputted by the input unit and the second vibration information generated by the generating unit,
wherein the estimating unit repeatedly estimates the at least one parameter based on a comparison result for the first vibration information and the second vibration information that has been regenerated by the generating unit using the estimated at least one parameter.
